(19) United States
(12) Patent Application Publication
(10) Pub. No.: US 2004/0142072 A1
(43) Pub. Date: Jul. 22, 2004

(54) Process and apparatus for infusing cranberry

(76) Inventor: John C.. Schwarz, Great Falls, MT (US)

Correspondence Address: BLANK ROME LLP, 600 NEW HAMPSHIRE AVENUE, N.W., WASHINGTON, DC, 20037, US

(21) Appl. No.: 10/701,663

(22) Filed: Nov. 6, 2003

Related U.S. Application Data
(60) Provisional application No. 60/423,988, filed on Nov. 6, 2002.

(51) Int. Cl. A23G 1/00

(52) U.S. Cl. 426/100

(57) ABSTRACT

The present invention relates to a processed berry product, in particular processed cranberry, more particularly a Russian cranberry (Vaccinium oxycoccus), which is so prepared that the fruit is infused with sugar but the original cranberry shape is maintained, and to processes and apparatuses for preparing such a processed berry product. A key step in preparing the cranberry is punching it with a tapered punch. Doing so allows sugar infusion while maintaining the shape of the cranberry. The tapered punch is a tubular rod having a diameter of about 2 to about 4 mm on the untapered end. One end of the rod is tapered to a sharp point. The length of the tapered end is about 1 to about 2 inches. The use of the tapered punch allows the Russian cranberry to maintain its form, allows for sugar infusion to take place, and after drying, results in a superior, higher moisture dried cranberry when compared to the dried North American cranberry.

### FIELD OF THE INVENTION

The present invention relates to a processed berry product, in particular processed cranberry, more particularly a Russian cranberry (Vaccinium oxycoccus), which is so prepared that the fruit is infused with sugar but the original cranberry shape is maintained, and to processes and apparatuses for preparing such a processed berry product.

### BACKGROUND OF THE INVENTION

The North American cranberry (Vaccinium macroparpon) and Russian cranberry (Vaccinium oxycoccus) are both recognized as cranberries by the U.S. Department of Agriculture (USDA). Both cranberries have high acid and vitamin C content and, if eaten raw, have a very tart taste, normally too tart for the consuming public. As a result, sugar is normally added to the cranberry to make it more palatable. In juices, compotes, sauces, and jams, the process of adding sugar is very simple in that the berries are crushed.

In making dried cranberries, if the berries are to have sugar added (sugar infusion), the sugar must penetrate the thick impermeable skin. If either the North American cranberry or the Russian cranberry is placed into a sugar solution, no sugar will enter the cranberry due to its thick impermeable skin. The North American manufacturers of dried cranberries using V. macroparpon, which is larger than the Russian cranberry, infuse sugar by slicing the cranberry. The sliced cranberry is then placed into a sugar solution before drying.

Other solutions to making sugar infused cranberry are also available. U.S. Pat. No. 6,387,438 to Reijiro Kato discloses a cranberry product which maintains the spherical form of the cranberry, and a process suitable for producing such a novel processed food. The processed cranberry product is produced in a process in which a plurality of holes are provided through the skin of frozen cranberries by puncturing treatment, then the cranberries are immersed in a sugar solution having a sugar content of 45 to 65 Brix degrees and heated until the sarcocarp is softened.

Processing of the Russian cranberry is more difficult in that it is much smaller than its American counterpart. When the Russian cranberry is sliced and processed as per the American cranberry, the whole cranberry falls apart and disintegrates during the process, leaving behind dry cranberry skins, which are unmerchantable. All of the meat of the Russian cranberry comes out with the juice during the drying process.

Applicant has found that nicking the cranberry with a thin meat tenderizing knife roller maintains most of the shape of the Russian cranberry and allows sugar infusion to occur. However, this process is not perfect in that some berries are nicked while others are sliced, resulting in an inconsistent process. Therefore, there remains a need for infusing cranberry that results in a consistent process while maintaining the cranberry in its original shape.

### SUMMARY OF THE INVENTION

Applicant has discovered that punching the Russian cranberry with a tapered punch allows sugar infusion while maintaining the shape of the cranberry. The tapered punch is a tubular rod having a diameter of about 2 to about 4 mm on the untapered end. One end of the rod is tapered to a sharp point. The length of the tapered end is about 1 to about 2 inches. The use of the tapered punch allows the Russian cranberry to maintain its form, allows for sugar infusion to take place, and after drying, results in a superior, higher moisture dried cranberry when compared to the dried North American cranberry.

In an embodiment of the present invention, the cranberry, preferably Russian cranberry, such as Vaccinium oxycoccus, is processed according to the process of FIG. 1, which contains the following steps:

1) Collecting the cranberries;

2) Freezing the cranberries;

3) Selecting properly sized cranberries;

4) Hand or machine punching;

5) Refreezing;

6) Infusing sugar;

7) Draining and washing;

8) Drying; and

9) Packaging.

### BRIEF DESCRIPTION OF THE DRAWINGS

FIG. 1 outlines the drying process of the present invention.

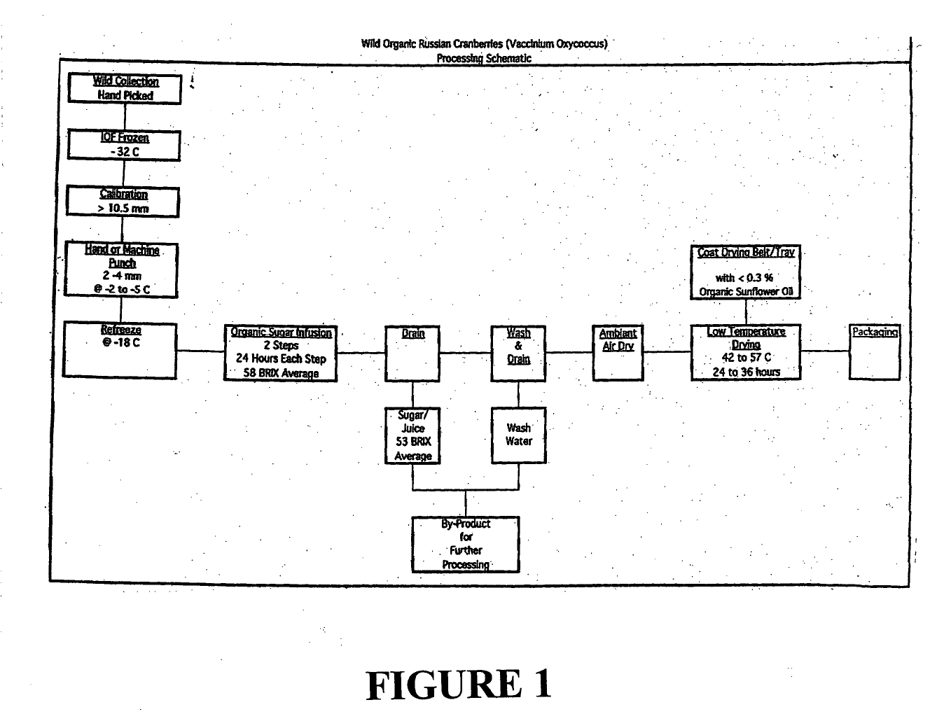

FIG. 2 shows a machine used to punch the cranberries.

FIG. 3 shows the tapered punch of the present invention.

### DETAILED DESCRIPTION OF THE PREFERRED EMBODIMENTS

Preferably, the cranberry processed in the method of the present invention is preferably a Russian cranberry of the species Vaccinium oxycoccus. This cranberry is smaller than the North American native cranberry Vaccinium macroparpon, hence its common name of “Small Cranberry.” Other common names of V. oxycoccus include for Bog Cranberry, Wild Cranberry, and Swamp Cranberry. Although referred to herein as Russian cranberry, V. oxycoccus can also be found in North America, from Alaska to Labrador, Greenland, and Newfoundland, south through New England, the northern portions of the Great Lakes States, and western Washington and Oregon; Europe; and Asia. The cranberry are preferably picked in areas designated BCS Oko-Garantie, in compliance with European Union (EU) and National Organic Program (NOP) regulations.

The picked cranberries are washed and frozen (individual quick freeze (IQF)) to preserve the flavor and freshness of the fruit. Preferably the freezing takes place in a blast freezer tunnel at about −32° C. for about 18 to about 24 hours. Other IQF freezers known in the art are also appropriate for the present invention, such as spiral freezers, belt freezers, tray freezers, dolly freezers, and retention time freezers.

The frozen cranberries are then selected so that larger cranberries having diameters greater than about 10.5 mm are selected for the infusion and drying process, while the smaller cranberries having diameters less than about 10.5 mm are discarded, generally to be used in making juice orjuice concentrate. The selection process preferably takes place at a temperature below freezing so the cranberries do not melt, become soft, and lose shape.

The selection process can be manual or automated, with the automated process being preferred for efficiency. With an automated process, the cranberries are passed through a vibrating screen that is properly sized to reject cranberries having diameters less than about 10.5 mm while retaining those having diameters greater than about 10.5 mm. Typically the pore size of the holes in the screen is such that cranberries smaller than about 10.5 mm pass through the hole and are discarded from the process, while cranberries larger than about 10.5 mm are retained on the screen and collected for sugar infusion and drying. Other processes known in the art for size selection are also appropriate for the present invention.

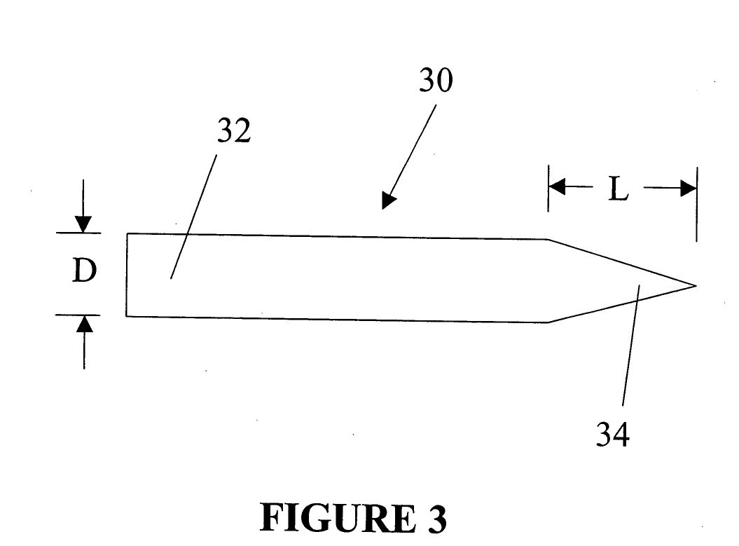

Once the proper size is selected, the cranberries are punched. This process uses a punch that is tapered at one end to a sharp point (see FIG. 3). The punch 30 is a tubular rod having a diameter (D) of about 2 to about 4 mm on the untapered end (32). The length (L) of the tapered end (34) is about 1 to about 2 inches. The pointy, tapered end (34) punctures the skin and penetrates the cranberries to allow sugar infusion into the flesh of the fruit. The punch may or may not pierce the berry completely through. Typically, however, the punched berry has a hole of about 2 to about 4 mm at the entrance point of the tapered punch and a smaller hole, preferably a small point, at the exit point. The tapered end (34) of the punch (30) allows puncture of the skin and penetration into the flesh of the cranberry without crushing the fruit. Further, expanding the size to about 2 to about 4 mm allows for a large enough hole to optimize the speed of sugar infusion but not so big as to drive out the flesh of the berry. The use of the tapered punch (30) allowed the Russian cranberry to maintain its form, allowed for sugar infusion to take place, and after drying, ended up with a superior, higher moisture dried cranberry when compared to the dried North American cranberry.

During the punching process, the cranberries are kept in a temperature range so as to be sufficiently frozen so that they do not collapse and lose their shape. The punching process is thus preferably carried out in the range of from about −2° C. to about −5° C. At higher temperatures, the cranberries will collapse upon being punched and will not roll properly in the punching machine. On the other hand, at lower temperatures, the frozen cranberry is too hard and will split upon being punched.

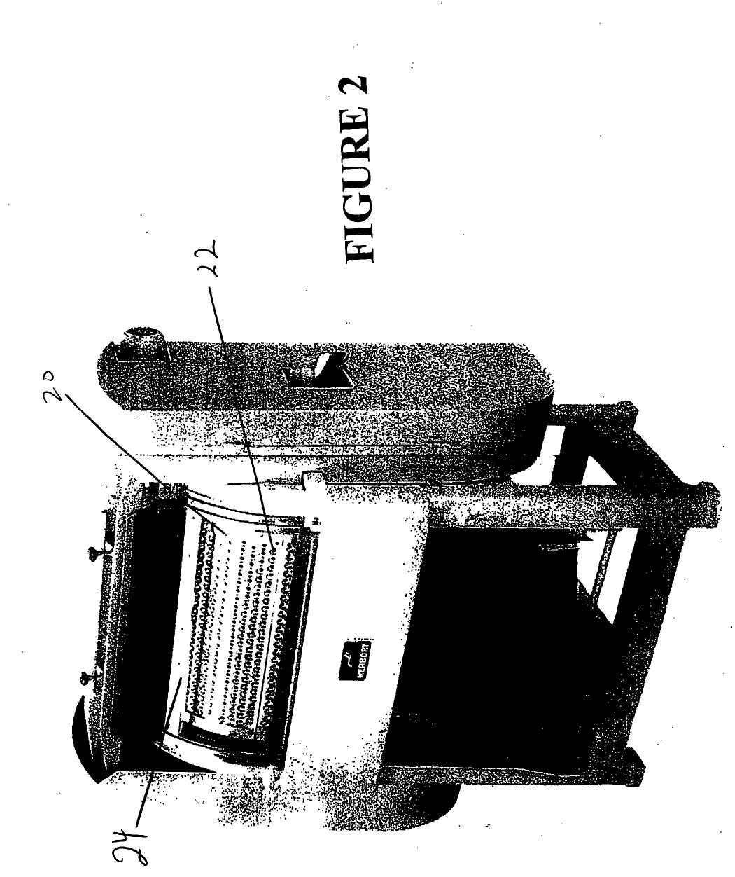

The punching process can be performed manually or mechanically. Preferably, a machine is used to punch the cranberries. In a preferred embodiment, the machine is a modified cherry pitter machine adopted to be used with the tapered punch. The machine is depicted in FIG. 2. The machine comprises a drum (20) having holes or indentations (22) to hold the cranberries in place for punching with the tapered punch. When the berries in the holes or indentations (22) reach the top (24) of the machine, an array of tapered punches matching the holes or indentations (22) is lowered to punch the berries. The berries then fall off the drum as it rotates to the back of the machine. A typical cherry pitter machine uses a blunt (non-tapered) punch of 8 to 10 mm in diameter. Therefore, the present invention modifies the cherry pitter with a smaller, tapered punch to be used with the smaller cranberries, which punctures the cranberries sufficiently to allow sugar infusion without destroying the shape of the cranberries.

In another embodiment, the berries are placed on a vibrating belt having a plurality of holes or indentations therein to hold the berries in place. The belt then enters a machine having an array of tapered punches matching the hole or indentation pattern on the belt, which is then lowered on to the berries to punch holes in the berries. The berries are then collected as they roll off the belt. After punching, the cranberries are preferably refrozen to about −18° C. to maintain their shape and for ease of handling.

The punched cranberries are then ready for sugar infusion, where the punched cranberries are infused with sugar by immersing the fruit in a sugar solution of preferably about 48° BRIX to about 68° BRIX, most preferably about 58° BRIX. The sugar used is preferably fructose or sucrose.

The amount of infusion bath employed relative to the weight of fruit treated will vary, but in general a weight ratio of fruit to infusion bath of from about 0.75:1 to about 1:1, and preferably 1:1, may be employed. During infusion the entire body of the fruit should be submerged in the bath.

The driving force for the infusion of the sugar solutes of the infusion bath into the fruit is the osmotic pressure of the system resulting from the fact that the sugar concentration of the bath is greater than the water soluble solids content of the fruit prior to infusion. The rate of infusion will increase as the temperature of the system is increased and/or as the concentration of the sugars in the infusion bath is increased. All other factors being equal, as the concentration of sugar in the bath is increased, the rate of infusion to the 32-55% water soluble solids level in the fruit will be enhanced. However, the fruit may suffer “osmotic shock” from a rapid infusion which occurs due to a great difference in the solids content in the bath and the fruit. This “osmotic shock” may reduce the original volume of the fruit by as much as 70%, and typically 40-60%.

Reduction in fruit volume loss is minimized by minimizing “osmotic shock.” This is accomplished by infusing the fruit by immersing it in at least two or more sugar containing baths of gradually increasing initial sugar concentration, so that the water soluble solids concentration of the fruit is increased in a step-wise and gradual manner, to the level of about 32-55%. In each bath the sugar solids concentration must be greater than the water soluble solids concentration of the fruit which is to undergo infusion. By this step-wise infusion method the original volume of the fruit may be reduced by only about 26-38%.

The weight percent sugar solids content of each of the sequential sugar containing baths may be about 1.7 to 4.5 times as great as the weight percent water soluble solids content of the fruit which is to undergo infusion, and preferably the sugar solids content of the bath is about 2.7 to about 3.7 times as great as the solids content of the fruit at the point at which it is immersed in the bath.

In a preferred embodiment of the present invention, the sugar infusion takes place in two 24 hour sequential batch steps in barrels that are rotated every two hours. The capacity of the barrels ranges from about 25 liters to about 250 liters, with the larger barrels preferably containing baffles therein. Although two sequential baths are preferred, any number of baths may be used during the sugar infusion process to arrive at the desired quality of the final product.

Various additives may be employed in the infusion bath in order to improve the texture of the final infused fruit product, or to enhance the stability of the fruit against possible leakage of the infused solutes from the fruit during storage. For example, low methoxyl pectin may be added in an amount of about 0.05% to about 0.25%, and preferably about 0.1% by weight of the infusion both. The low methoxyl pectin aids in preventing leakage of the infused solutes from the fruit. In addition, texture-improving agents, such as calcium salts (e.g. calcium hydroxide) may be added to the infusion baths to selectively stiffen the texture of a fruit which may have an undesirably soft consistency.

The multiple bath infusion process is preferably conducted at room temperature, although the temperature may range from about 45° F. to about 120° F. As an alternative to a sequential infusion process, the fruit may be infused by treatment in a single bath by immersing the fruit in an infusion bath at room temperature, followed by a period of immersion at conventional refrigerator temperatures of about 34° F.-48° F., e.g., preferably about 40° F. The processing time required to reach a water soluble solids content in the fruit of about 32% to about 55% will vary depending upon a number of factors including the sugar solids content of the bath, the temperature, and the porosity of the fruit undergoing infusion. In general, however, the infusion process may require from about 20 to 60 hours. Undesirable enzymatic browning of the fruit is avoided by carrying at least a portion of the infusion period at refrigerator temperatures, although the entire process may be conducted at room temperatures.

Once the infusion process is completed, the cranberries are drained and washed. The washing should be sufficient to remove the surface juice and sugar from the cranberries. Once washing is completed, the surface water is removed from the cranberries by exposing them to blowing air currents. The cranberries are then ready for drying.

The bath which is separated from the fruit upon completion of the infusion process is in itself a useful food product, or food base which may be further processed into a desired food product. During the infusion process fruit juices infuse into the bath providing it with a fruit flavor. For example, the post-infusion bath may be employed as a milk additive or pancake additive. Moreover, the bath combined with the infused fruit may be employed as fruit-syrup food topping or sauce, or it may be mixed with ice cream, yogurt products, etc.

The post-infusion bath may also be treated with any of a number of conventional thickeners, and utilized alone or in combination with the infused fruit product as a pie or donut filling, as an additive to yogurt or yogurt mixes, as an ice-cream or cake topping, as a pastry filling, as well as a sauce or pudding product, etc.

Starches may be employed to thicken the post-infusion bath. The starches employed to treat the bath may be chemically modified starches from potato, arrowroot, corn, rice, wheat, maize, sorghum and waxy sorghum. Tapioca starch may also be employed. In general from about 1% to about 4.5% starch may be added to the infusion bath to adjust it to the desired viscosity. In addition to, or in the alternative to, starches, gums may be employed as thickeners; e.g. alginates, carageenans, locust beam gum, guar gum and cellulose gums.

Other conventional food additives may be added to the post-infusion bath. Typical of such ingredients are flavoring agents, salt, fats and emulsifiers, colorants, vitamins, minerals or the like. Suitable flavorings can be employed to impart vanilla, cream, chocolate, coffee, maple, spice, mint, butter, caramel, fruit and other desired flavorings.

In another embodiment, the post-infusion bath may advantageously be reused for subsequent infusion process. To be reused, however, the post-infusion bath must be treated so that its sugar and additive contents are appropriate for an infusion bath solution.

The drying process can proceed as commonly known in the art, such as that for the North American cranberries. In a preferred embodiment, however, the drying process is slower that commonly used for the North American cranberries. In this preferred embodiment, the cranberries are first coated with small coating of oil so that the final product does not stick together. To accomplish oil coating, the drying belts or trays are coated with oil, preferably less than about 0.3% organic sunflower oil, before the start of the drying process so as to put a thin coating of oil on the berries. In the North American cranberry process, the oil is sprayed on after drying. For the Russian cranberry, however, the process requires less oil because the oil tends to remain on the belt or tray, which needs to be cleaned off before the next cycle. This residual oil can be cleaned off before the next cycle.

The oil coated, sugar infused cranberries are dried at about 42° to about 57° C. air temperature in an electric drier with a dehumidifier for about 24 to about 36 hours. The dryer is controlled such that the berries have an internal temperature of about 3° C. less than the drying air. For the North American cranberry, it is dried in about 4 to about 6 hours at a higher temperature. The slow low temperature drying of the present invention allows for higher moisture finished product that has a soft pleasant texture as opposed to a hard chewy surface from the faster and higher temperature process.

Once dried the cranberries are packed in retail packs, preferably about 150 gram, or bulk cartons, preferably about 15 kilograms.

Preferably, the steps prior to and including sugar infusion are operated as batch processes; and steps after sugar infusion are operated as continuous flow processes. The berry fruit obtained by the process of the present invention is whole and intact, and has a moist texture and improved taste when compared to conventional dried sugar infused fruit which tends to be chewy and tough.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claim is:

1. A process for infusing cranberries comprising the steps of
a) punching the cranberries with a tapered punch; and
b) submerging the cranberries in a sugar bath.

2. The process of claim 1, wherein the cranberries in step a) are frozen at about −2 to about −5° C.

3. The process of claim 1, wherein the sugar bath has a sugar content of about 48 to about 68° BRIX.

4. The process of claim 1, wherein the tapered punch is tubular rod having a diameter of about 2 to about 4 mm at an untapered end.

5. The process of claim 1, wherein the tapered punch is tapered to a point at one end.

6. The process of claim 1, wherein the taper of the tapered punch has a length of about 1 to about 2 inches.

7. The process of claim 1, wherein the cranberries have diameters of greater than about 10.5 mm.

8. The process of claim 1, wherein the cranberries are Vaccinium oxycoccus.

9. The process of claim 1, wherein step b) takes place in two 24 hour sequential batch steps in barrels that are rotated every two hours.

10. The process of claim 9, wherein the barrels are baffled.

11. The process of claim 9, wherein the barrels has capacities of about 25 liters to about 250 liters.

12. The process of claim 1, further comprising the step of
c) drying the infused cranberries.

13. The process of claim 12, wherein the cranberries are coated with oil before drying.

14. The process of claim 13, wherein the oil is less than 0.3% organic sunflower oil.

15. The process of claim 12, wherein step c) takes place at about 42 to about 57° C. for about 24 to about 36 hours.

16. The process of claim 12, wherein step c) is a continuous process.

17. The process of claim 1, wherein steps a) and b) are batch processes.

18. A tapered punch for punching cranberries comprising a tubular rod having a first end and a second end, said first end is tapered to a point.

19. The tapered punch of claim 18, wherein the tubular rod had a diameter of about 2 to about 4 mm.

20. The tapered punch of claim 18, wherein the taper of the first end is about 1 to about 2 inches.
